(19) United States
(12) Patent Application Publication
(10) Pub. No.: US 2005/0052280 A1
(43) Pub. Date: Mar. 10, 2005

(54) Microcomputer having security function

(75) Inventors: Kazuhiko Fukushima, Hyogo (JP); Atsuo Yamaguchi, Hyogo (JP)

Correspondence Address: McDermott, Will & Emery LLP, 600 13th Street, N.W., Washington, DC, 20005-3096, US

(73) Assignees: RENESAS TECHNOLOGY CORP.; RENESAS LSI DESIGN CORPORATION

(21) Appl. No.: 10/931,970

(22) Filed: Sep. 2, 2004

(30) Foreign Application Priority Data
Sep. 4, 2003 (JP) 2003-312740(P)

(51) Int. Cl. H04L 9/32

(52) U.S. Cl. 340/425.5

(57) ABSTRACT

When a CPU proceeds to an interruption process, a value permitting an access to a security-related area is set in a flag register, and when the CPU returns from the interruption process, a value prohibiting an access to the security-related area is set in the flag register. A resource selecting signal generating circuit generates access signals for accessing to various areas in a non-volatile memory and an RAM, in accordance with the flag stored in the flag register. Therefore, when the security-related area is held as an interruption processing area, it becomes possible to prevent an access to the security-related area from a security-non-related program area, and hence, it becomes possible to prevent leakage of security-related information.

### BACKGROUND OF THE INVENTION

1. Field of the Invention

The present invention relates to a microcomputer having a security function and, more specifically, to a microcomputer having such a scheme in which one CPU (Central Processing Unit) executes processes related to security information as well as processes not related to security information, and in which the security information cannot be accessed from any process that is not related to the security information.

2. Description of the Background Art

Recently, microcomputers having a security function have been vigorously developed. Generally, a microcomputer containing key information and having a security function such as a random number generating function, an encryption function or an authentication function is often developed and implemented as a product in an isolated environment that can prevent leakage of security information.

A microcomputer executing a process not related to security information, such as human I/F, equipment control or transmission/reception of information is often designed in a general environment. These microcomputers are generally connected together and incorporated in equipments. Related techniques are disclosed, for example, in Japanese Patent Laying-Open Nos. 2001-256460 and 8-272625.

A one-chip microcomputer disclosed in Japanese Patent Laying-Open No. 2001-256460 includes: a monitor flag that is set when a program in a specific address space is being executed; an access permission address range setting register setting an address range to which access is permitted while the monitor flag is set; an access permission area detecting circuit determining whether or not an access is made within the set address range; an access permission setting register setting whether an access to an area out of the address range is to be permitted or not; and a memory read control circuit and a memory write control circuit, which control access to a non-volatile memory based on the result of determination by the access permission area detecting circuit and the contents set by the access permission setting register.

A multi-program execution control apparatus disclosed in Japanese Patent Laying-Open No. 8-272625 includes: a CPU; a memory; a program access permission area setting circuit identifying an ID (IDentifier) of a program to be executed, setting an area to which access by the program is permitted, and setting an address at which an operation is started when the operation is switched to the program; and a program access control circuit detecting whether an address accessed by the program that is being executed is a permitted address or non-permitted address, and when it is a non-permitted address, generating a signal for interrupting the CPU based on the detected signal and generating a signal prohibiting an access to the memory corresponding to the non-permitted address.

When the microcomputer having the security function and the microcomputer executing a process not related to security information are connected together to be incorporated in equipments, there arises a problem of complicated system or increased circuit scale.

In the one-chip microcomputer disclosed in Japanese Patent Laying-Open No. 2001-256460, it is possible to prevent one application program from accessing to an instruction code or data of the other program, enhancing security. When a plurality of application programs are in operation, however, processes including register setting are required every time a program switch or the like occurs, increasing a burden on the software.

In the multi-program execution control apparatus disclosed in Japanese Patent Laying-Open No. 8-272625 also, it is possible to prevent a program from accessing to another program, to enhance safety of program and data. When a plurality of application programs are in operation, however, register contents must be frequently updated at every program switch, and therefore, the burden on the software increases.

### SUMMARY OF THE INVENTION

An object of the present invention is to provide a microcomputer that can alleviate the burden on the software and allows easy security management.

According to an aspect, the present invention provides a microcomputer executing a process while accessing to a specific area and a remaining non-specific area of a resource, including: a processor; a storing unit storing a flag limiting an access to the specific area; a setting unit setting a value permitting an access to the specific area in the storing unit when the processor enters an interruption process and setting a value prohibiting an access to the specific area in the storing unit when the processor returns from the interrupting process; and a control unit controlling an access to the specific and the non-specific area in accordance with the flag stored in the storing unit.

Therefore, access from the non-specific area to the specific area is impossible, and leakage of security-related information in the specific area can be prevented.

According to another aspect, the present invention provides a microcomputer executing a process while accessing to a specific area and a remaining non-specific area of a resource, including: a processor; a counter incrementing a count value when the processor enters an interruption process and decrementing the count value when the processor returns from the interrupting process; and a control unit controlling an access to the specific and the non-specific areas in accordance with the count value of the counter.

Therefore, when the specific area is regarded as the interruption processing area, access from the non-specific area to the specific area can be prevented, and leakage of security-related information in the specific area can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically representing a configuration of a microcomputer in accordance with a first embodiment of the present invention.

FIG. 2 represents a circuit configuration for generating an interruption execution notifying signal 100 and an interruption return notifying signal 101.

FIG. 3 is an illustration showing timings of interruption execution notifying signal 100 and interruption return notifying signal 101.

FIGS. 4A and 4B are illustrations representing a software processing by the microcomputer in accordance with the first embodiment of the present invention.

FIG. 5 is a block diagram schematically representing a configuration of a microcomputer in accordance with a second embodiment of the present invention.

FIG. 6 is an illustration representing software processing by the microcomputer in accordance with the second embodiment of the present invention.

FIG. 7 is a block diagram schematically representing a configuration of a microcomputer in accordance with a third embodiment of the present invention.

FIG. 8 is an illustration representing software processing by the microcomputer in accordance with the third embodiment of the present invention.

FIG. 9 is a block diagram schematically representing a configuration of a microcomputer in accordance with a fourth embodiment of the present invention.

FIG. 10 represents a configuration of a control circuit of a base address register.

FIG. 11 is a block diagram schematically representing a configuration of a microcomputer in accordance with a fifth embodiment of the present invention.

FIG. 12 shows an exemplary configuration of a resource selection signal generating circuit 2 in accordance with the fifth embodiment of the present invention.

FIG. 13 is an illustration representing a software processing by the microcomputer in accordance with the fifth embodiment of the present invention.

FIG. 14 a block diagram schematically representing a configuration of a microcomputer in accordance with a sixth embodiment of the present invention.

FIG. 15 shows an exemplary configuration of a resource selection signal generating circuit 2 in accordance with the sixth embodiment of the present invention.

### DESCRIPTION OF THE PREFERRED EMBODIMENTS

(First Embodiment)

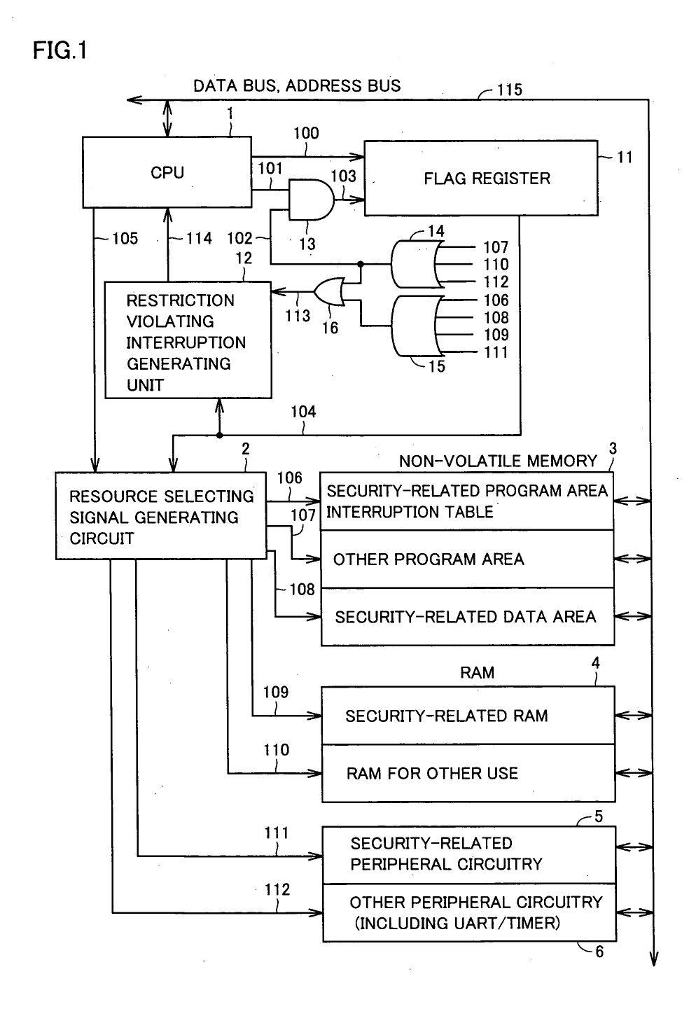

FIG. 1 is a block diagram schematically representing a configuration of a microcomputer in accordance with a first embodiment of the present invention. The microcomputer includes a CPU 1, a resource selecting signal generating circuit 2 generating a signal for selecting a resource such as a memory and peripheral circuitry, a non-volatile memory 3, an RAM (Random Access Memory) 4, security-related peripheral circuitry 5 including an encryption circuit, a random number generating circuit or the like, security-unrelated peripheral circuitry 6 including an UART (Universal Asynchronous Receiver-Transmitter), a timer or the like, a flag register 11, a restriction violating interruption generating circuit 12, an AND circuit 13, and OR circuits 14 to 16.

Non-volatile memory 3 includes a security-related program area and an interruption table (hereinafter simply referred to as a security-related program area), other program areas, and a security-related data area. RAM 4 includes a security-related RAM area and an RAM area for other use.

Resource selecting signal generating circuit 2 decodes an upper address on an address bus 105 output from CPU 1, and generates an access signal 107 for accessing to other program area, an access signal 110 for accessing to the RAM area for other use, and an access signal 112 for accessing to other peripheral circuitry. These access signals are not masked by a security-related access prohibiting signal 104 output from flag register 11.

Further, resource selecting signal generating circuit 2 decodes an upper address on an address bus 105 output from CPU 1, and generates an access signal 106 for accessing to the security-related program area, an access signal 108 for accessing to the security-related data area, an access signal 109 for accessing to the security-related RAM area and an access signal 111 for accessing to the security-related peripheral circuitry. These access signals are masked by security-related access prohibiting signal 104 output from flag register 11. Specifically, when security-related access prohibiting signal 104 is “0”, these access signals are output, and when security-related access prohibiting signal 104 is “1”, these access signals are masked and not output. It is noted that security-related access prohibiting signal 104 permits access to the security-related information when it is “0” and prohibits access to the security-related information when it is “1”.

OR circuit 14 outputs “1” when access signal 107 for accessing to other program area, access signal 110 for accessing to the RAM area for other use or access signal 112 for accessing to other peripheral circuitry is output, and otherwise outputs “0”.

OR circuit 15 outputs “1” when access signal 106 for accessing to the security-related program area, access signal 108 for accessing to the security-related data area, access signal 109 for accessing to the security-related RAM area or access signal 111 for accessing to the security-related peripheral circuitry is output, and otherwise outputs “0”.

Flag register 11 attains to “0” when interruption execution notifying signal 100 output from CPU 1 is active, and outputs “0” to security-related access prohibiting signal 104. Further, when interruption return notifying signal 101 output from CPU 1 is active and any of the access signal 107 for accessing to other program area, access signal 110 for accessing to RAM area for other use and the access signal 112 for accessing to other peripheral circuitry is active, flag register 11 attains to “1” and outputs “1” to security-related access prohibiting signal 104.

Restriction violating interruption generating circuit 12 outputs a restriction violating interruption signal 114 to CPU 1 when security-related access prohibiting signal output from flag register 14 is “0” and “0” is output form OR circuit 16. Specifically, restriction violating interruption generating circuit 12 outputs the restriction violating interruption signal to CPU 1, when access to the security-related information is prohibited and CPU 1 makes an access to the security-related information.

By way of example, assume that CPU 1 tries to fetch an instruction code from the security-related program area while an access to the security-related information is prohibited. In that case, as an instruction code is not output from non-volatile memory 3, CPU 1 may possibly overrun. In order to prevent such a situation, the restriction violating interruption signal is output to CPU 1, to cause an error processing.

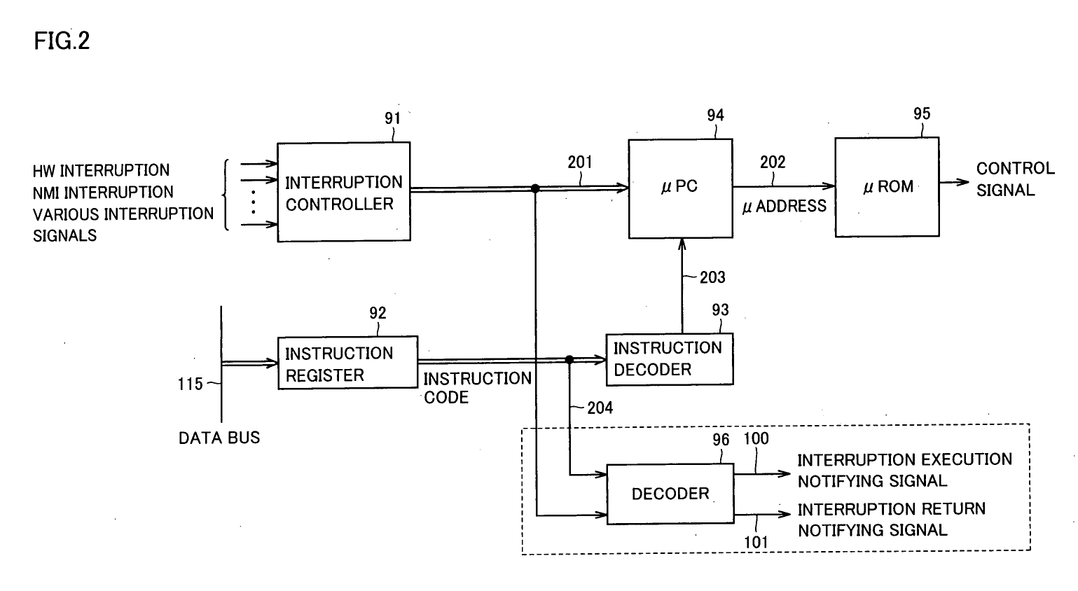

FIG. 2 represents a circuit configuration for generating interruption execution notifying signal 100 and interruption return notifying signal 101. FIG. 2 shows a part of a circuit in CPU 1, including an instruction decoder 93 decoding an instruction code stored in instruction register 92, a μPC (μ program counter) 94, a μ ROM 95 storing a μ code, and a decoder 96.

Interruption controller 91 receives various hardware interruptions and an NMI (Non Maskable Interrupt), and outputs a code 201 indicating the type of interruption to μPC 94 and decoder 96. Further, instruction decoder 93 decodes instruction code 204 stored in instruction register 92, and outputs the result of decoding 203 to μPC 94.

The μPC 94 receives code 201 indicating the type of interruption and the result of decoding 203, and outputs a μ address 202 for selecting a corresponding μ code to μ ROM 95. The μ ROM 95 receives p address 202 from μPC 94, and outputs a control signal (μ code) for controlling CPU 1.

Decoder 96 receives code 201 output from interruption controller 91 and instruction code 204 output from instruction register 92, decodes these codes and generates interruption execution notifying signal 100 and interruption return notifying signal 101. Specifically, when a code 201 indicating a hardware interruption or an NMI is received from interruption controller 91, or when instruction code 204 output from instruction register 92 is an interruption instruction, decoder 96 renders active the interruption execution notifying signal 100. When instruction code 204 output from instruction register 92 is an interruption return instruction, decoder 96 renders active the interruption return notifying signal 101.

Though FIG. 2 shows an example for a CISC (Complex Instruction Set Computer) type CPU1, the configuration is also applicable to a RISC (Reduced Instruction Set Computer) type one.

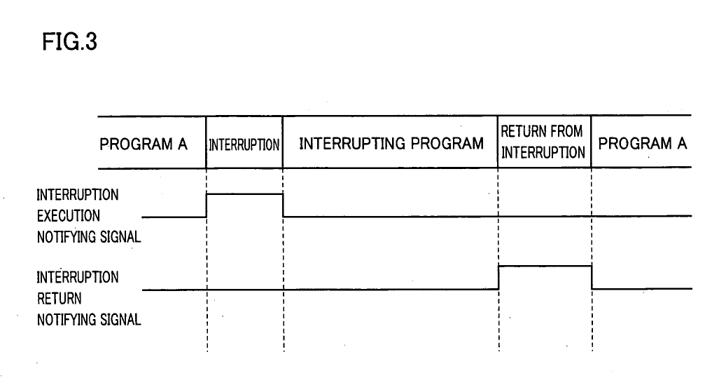

FIG. 3 is an illustration showing timings of interruption execution notifying signal 100 and interruption return notifying signal 101. When an interruption occurs while CPU 1 is executing program A, interruption execution notifying signal 100 is rendered active, and an interruption sequence such as PC save is executed. Thereafter, the process of CPU 1 proceeds to the interrupting program.

When the process of the interrupting program is complete and CPU 1 executes an interruption return instruction, the interruption return signal is rendered active, and a process such as PC return takes place. Thereafter, CPU 1 resumes the processing of program A.

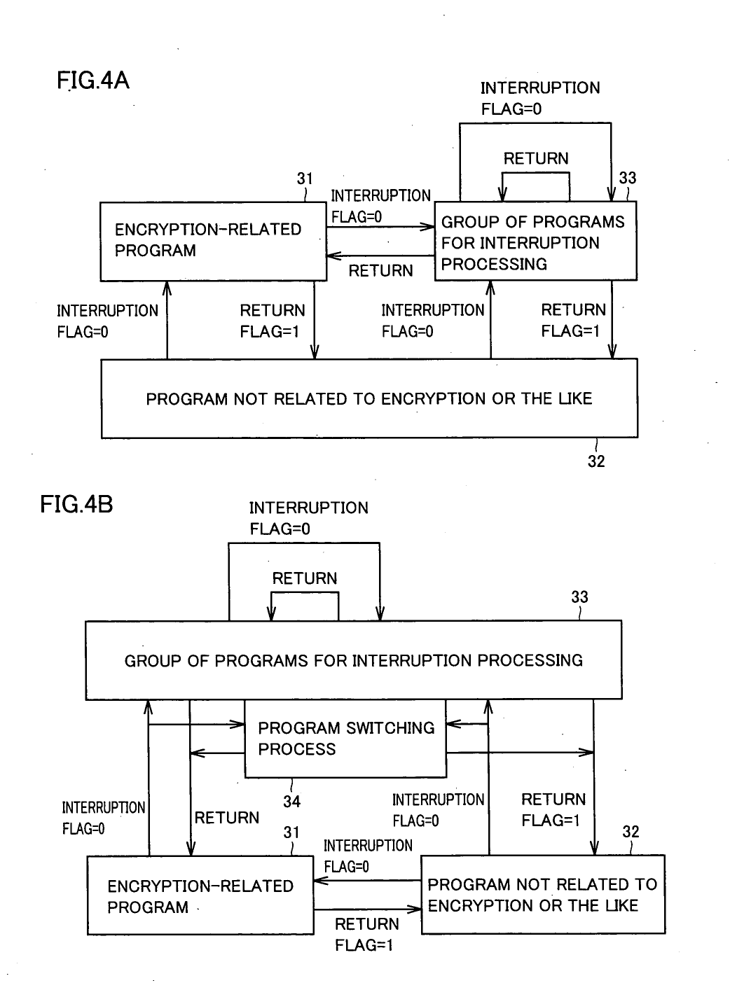

FIGS. 4A and 4B are illustrations representing a software processing by the microcomputer in accordance with the first embodiment of the present invention. FIG. 4A shows a process without task switching. The software includes an encryption-related program 31, a program 32 not related to encryption or the like, and a group of programs 33 for interruption processing.

When CPU 1 makes a transition from program 32 not related to encryption or the like to encryption-related program 31, “0” is set in flag register 11 (FLAG). Transition from program 32 not related to encryption or the like to encryption-related program 31 occurs when an interruption instruction is executed. When the control returns from encryption-related program 31 to program 32 not related to encryption or the like, an interruption return instruction is executed and “1” is set in flag register 11 (FLAG).

When an interruption occurs while CPU 1 is executing encryption-related program 31, flag register 11 (FLAG) maintains “0”, and the process proceeds to the group of programs 33 for interruption processing. When the control returns from the group of programs 33 for interruption processing to encryption-related program 31, an interruption return instruction is executed, while flag register 11 (FLAG) maintains “0”. It is noted that when interruption occurs again while CPU 1 is executing the process of the group of programs 33 for interruption processing, flag register 11 (FLAG) maintains “0”. Further, even when CPU 1 executes the interruption return instruction and returns to the original program of interruption processing, flag register 11 (FLAG) maintains “0”.

When an interruption occurs while CPU 1 is executing program 32 not related to encryption or the like, “0” is set in flag register 11 (FLAG), and the process proceeds to the group of programs 33 for interruption processing. When the control returns from the group of programs 33 for interruption processing to program 32 not related to encryption or the like, an interruption return instruction is executed, and “1” is set in the flag register 11 (FLAG).

FIG. 4B shows a process with task switching. The software includes encryption-related program 31, program 32 not related to encryption or the like, group of programs 33 for interruption processing, and a program switching process 34.

When CPU 1 makes a transition from program 32 not related to encryption or the like to encryption-related program 31, when control returns from encryption-related program 31 to program 32 not related to encryption or the like, when an interruption occurs while encryption-related program 31 is being executed, when control returns from group of programs 33 for interruption processing to encryption-related program 31, when an interruption occurs while program 32 not related to encryption or the like is being executed, and when the control returns from group of programs 33 for interruption processing to program 32 not related to encryption or the like, processes similar to those as described with reference to FIG. 4A are performed.

When the program switching process 34 occurs while CPU 1 is executing program 32 not related to encryption or the like, “0” is set in flag register 11 (FLAG). Even when the program switching process 34 ends and the process proceeds to encryption-related program 31, flag register 11 (FLAG) maintains “0”. The program switching process 34 is caused by a hardware interruption, as in the case of a common task switching.

When the program switching process 34 occurs while CPU 1 is executing encryption-related program 31, flag register 11 (FLAG) maintains “0”. When the program switching process 34 ends and the process proceeds to program 32 not related to encryption or the like, “1” is set in flag register 11 (FLAG).

As described above, in the microcomputer in accordance with the present embodiment, when the interruption execution notifying signal is active, that is, when the control proceeds to encryption-related program 31 or to group of programs 33 for interruption processing, flag register 11 is set to “0” to permit access to the security-related information, and when program 32 not related to encryption or the like is being executed, flag register 11 is set to “1” to prohibit an access to the security-related information. Therefore, even when the microcomputer is shipped with security-related programs or interruption processing programs contained therein, it is impossible for a client to access to the security-related programs or interruption processing programs. Thus, leakage of security-related information can be prevented.

Further, as the interruption table is arranged in the security-related program area, a program not related to encryption or the like cannot change the contents of the interruption table. Thus, leakage of security-related information can be prevented.

(Second Embodiment)

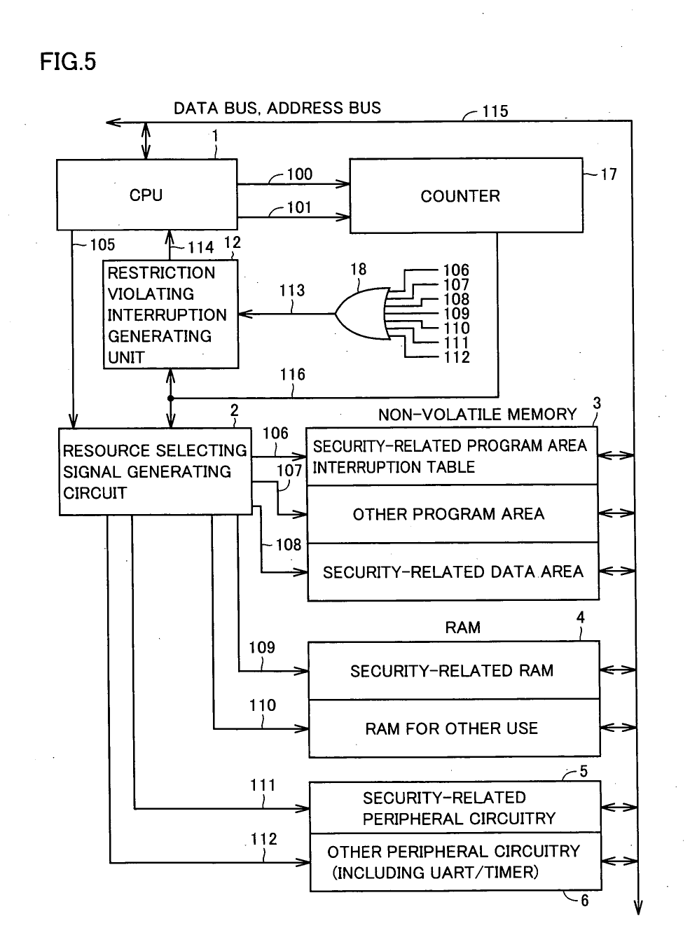

FIG. 5 is a block diagram schematically representing a configuration of a microcomputer in accordance with a second embodiment of the present invention. Different from the microcomputer in accordance with the first embodiment shown in FIG. 1, flag register 11 is replaced by a counter 17, the interruption return notifying signal is directly input to counter 17 and OR circuits 14 to 16 are replaced by an OR circuit 18. Though OR circuits 14 to 16 shown in FIG. 1 are replaced by OR circuit 18, the configuration is logically equivalent.

When interruption execution notifying signal 100 output from CPU 1 is rendered active, counter 17 increments the count value by 1, and when interruption return notifying signal 101 output from CPU 1 is rendered active, counter 17 decrements the count value by 1. When the count value is “0”, counter 17 outputs “1” to security-related access prohibiting signal 116, and when the count value is “1” or larger, counter 17 outputs “0” to security-related access prohibiting signal 116.

The count value of counter 17 represents nesting of interruption (depth of multiple interruptions at that time). Therefore, when the count value is “0”, it means that a program not related to security is being executed, and therefore, access to the security information is prohibited. When the count value is “1” or larger, it means that a security-related program is being executed, and therefore, an access to the security information is permitted.

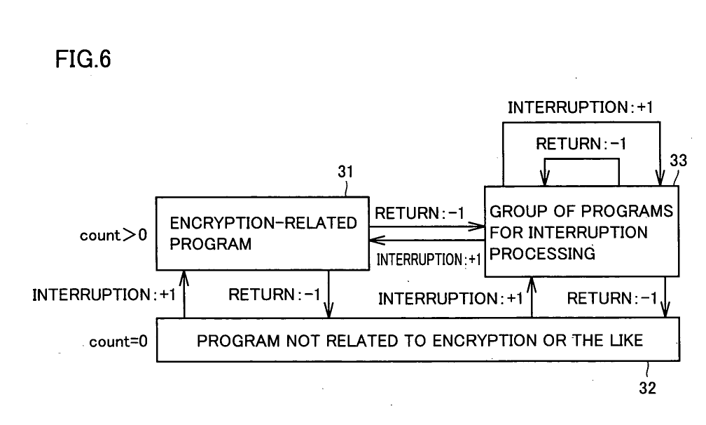

FIG. 6 is an illustration representing a software processing by the microcomputer in accordance with the second embodiment of the present invention. When CPU 1 makes a transition from program 32 not related to encryption or the like to encryption-related program 31, an interruption instruction is executed and the count value of counter 17 is incremented by “1” to “1”. As a result, counter 17 outputs “0” to security-related access prohibiting signal 116, permitting an access to the security information.

When control returns from encryption-related program 31 to program 32 not related to encryption or the like, an interruption return instruction is executed, and the count value of counter 17 is decremented by “1” to “0”. As a result, counter 17 outputs “1” to security-related access prohibiting signal 116, prohibiting an access to the security information.

When an interruption occurs while CPU 1 is executing encryption-related program 31, counter 17 increments the count value by “1” to “2”, and therefore, the value of security-related access prohibiting signal 116 is maintained at “0”, and the process proceeds to the group of programs 33 for interruption processing. When control returns from the group of programs 33 for interruption processing to encryption-related program 31, an interruption return instruction is executed, the count value of counter 17 is decremented by “1” to “1”, and the value of security-related access prohibiting signal 116 is maintained at “0”.

When an interruption occurs again while CPU 1 is executing the process of the group of programs 33 for interruption processing, the nesting becomes deeper, and the value of security-related access prohibiting signal is maintained at “0”. When CPU 1 executes an interruption return instruction and returns to the original interrupting process program, the count value of counter 17 is decremented by “1”, while the value of security-related access prohibiting signal is maintained at “0”.

When an interruption occurs while CPU 1 is executing the program 32 not related to encryption or the like, counter 17 increments the count value by “1” to “1”, “0” is output to security-related access prohibiting signal 116, and the process proceeds to the group of programs 33 for interruption processing. When the control returns from the group of programs 33 for interruption processing to program 32 not related to encryption or the like, an interruption return instruction is executed, counter 17 decrements the count value by “1” to “0”, and “1” is output to security-related access prohibiting signal 116.

In the foregoing, when the count value is “0”, counter 17 outputs “1” to security-related access prohibiting signal 116, and when count value is “1” or larger, it outputs “0” to security-related access prohibiting signal 116. It may be possible to output “1” to security-related access prohibiting signal 116 when the count value is not larger than n (1≦n) and to output “0” to security-related access prohibiting signal 116 when the count value is larger than n.

As described above, in the microcomputer in accordance with the present embodiment, when the interruption execution notifying signal is active, that is, when the control proceeds to encryption-related program 31 or to the group of programs 33 for interruption processing, counter 17 increments the count value to permit access to the security information, and when the program 32 not related to encryption or the like is being processed, counter 17 sets the count value to “0” to prohibit access to the security-related information. Therefore, the same effect as attained by the microcomputer in accordance with the first embodiment can be attained.

(Third Embodiment)

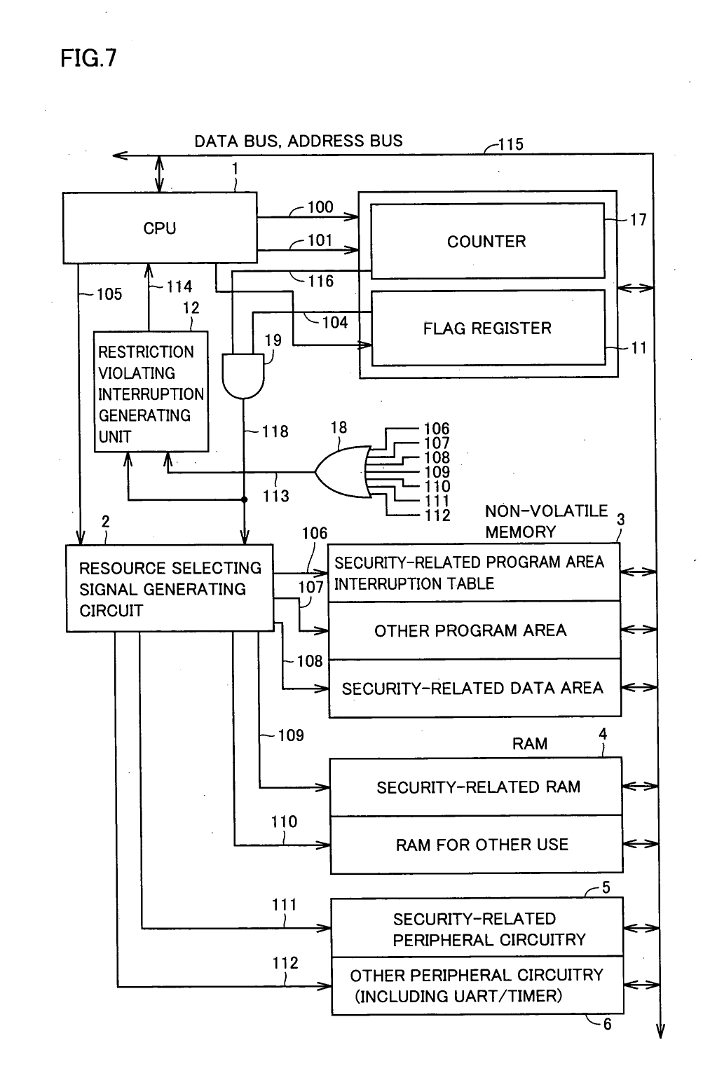

FIG. 7 is a block diagram schematically representing a configuration of a microcomputer in accordance with a third embodiment of the present invention. Different from the microcomputer in accordance with the second embodiment shown in FIG. 5, a flag register 11 and an AND circuit 19 are added, and setting of flag register 11 is done by CPU 1.

At the time of a program switching, CPU 1 sets “0” in flag register 11 when a program not related to encryption or the like is switched to an encryption-related program, and sets “1” in flag register 11 when an encryption-related program is switched to a program not related to encryption or the like. In the present embodiment, it is assumed that transition from a program not related to encryption or the like to an encryption-related program is not caused by execution of an interruption program.

AND circuit 19 outputs a logical product of a security-related access prohibiting signal 104 output from flag register 11 and security-related access prohibiting signal 116 output from counter 17. Specifically, when the count value of counter 17 is not smaller than “1”, or when “0” is set in flag register 11, AND circuit 19 outputs “0” to resource selecting signal generating circuit 2, permitting an access to the security information.

When the count value of counter 17 is “0” and “1” is set in flag register 11, AND circuit 19 outputs “1” to resource selecting signal generating circuit 2, prohibiting an access to the security information.

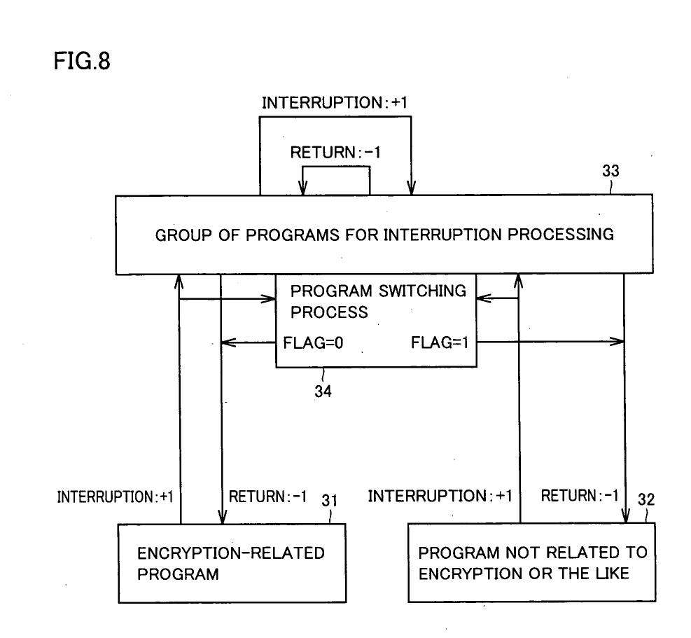

FIG. 8 is an illustration representing a software processing by the microcomputer in accordance with the third embodiment of the present invention. At a transition from the program 32 not related to encryption or the like to encryption-related program 31, program switching process 34 is executed, and “0” is set in flag register 11 (FLAG). When the control returns from encryption-related program 31 to the program 32 not related to encryption or the like, program switching process 34 is executed, and “1” is set in flag register 11 (FLAG).

When an interruption occurs while CPU 1 is executing encryption-related program 31, when an interruption occurs again while CPU 1 is executing the process of the group of programs 33 for interruption processing, and when an interruption occurs while CPU 1 is executing the program 32 not related to encryption or the like, processes similar to those described with reference to FIG. 6 are performed.

As described above, in the microcomputer of the present embodiment, when the process is switched from the program 32 not related to encryption or the like to encryption-related program 31, “0” is set in flag register 11 to permit an access to the security-related information, and when the process returns from encryption-related program 31 to the program 32 not related to encryption or the like, “1” is set in flag register 11 to prohibit an access to the security-related information. Therefore, the same effect as attained by the microcomputer in accordance with the first embodiment can be attained.

(Fourth Embodiment)

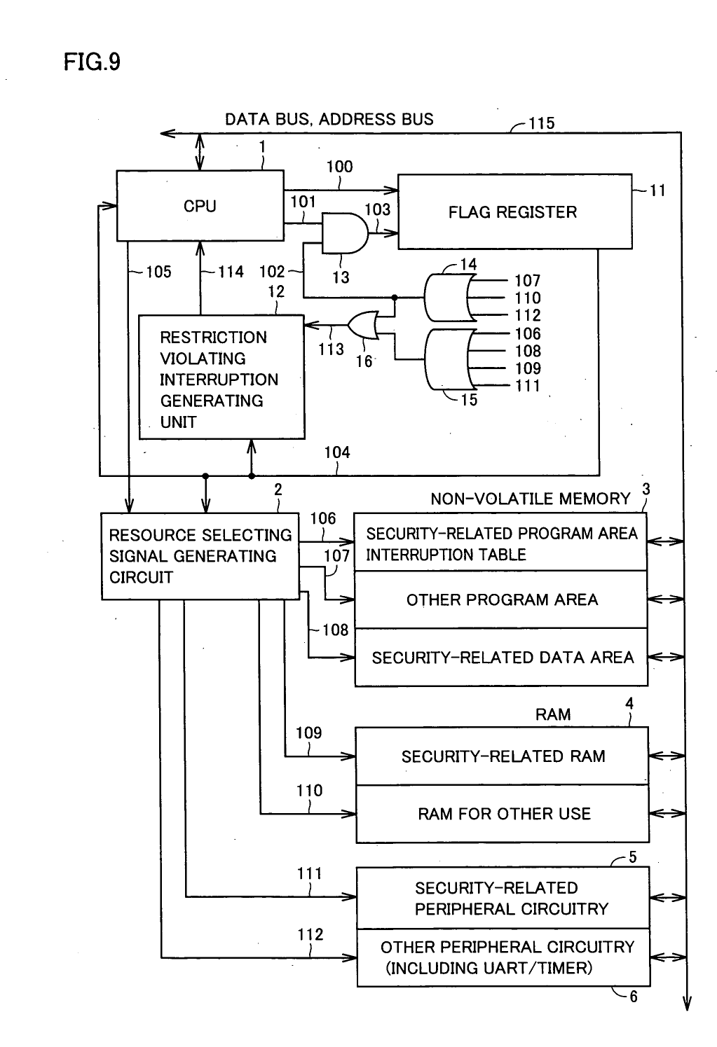

FIG. 9 is a block diagram schematically representing a configuration of a microcomputer in accordance with a fourth embodiment of the present invention. As compared with the microcomputer in accordance with the first embodiment shown in FIG. 1, the present embodiment differs only in that security-related access prohibiting signal 104 is input to CPU 1 and that the control circuit for the base address register of an interruption table in CPU 1 has a different configuration. Therefore, detailed description of overlapping configurations and functions will not be repeated here.

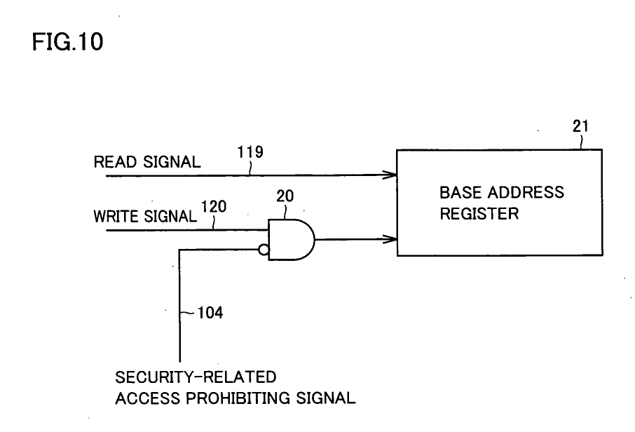

FIG. 10 represents the configuration of the control circuit of the base address register. A base address register 21 stores base addresses of the interruption table. When the contents of base address register 21 are rewritten, the security-related program may possibly fail to operate properly, or security would be undermined. Therefore, base address register 21 is adapted such that the contents thereof can be rewritten only by the security-related program.

When security-related access prohibiting signal 104 is “1”, AND circuit 20 masks a WRITE signal 120 to base address register 21, and when security-related access prohibiting signal 104 is “0”, directly outputs the WRITE signal 120 to base address register 21. A READ signal 119 to base address register 21 is not influenced by security-related access prohibiting signal 104.

In the present embodiment, rewriting of the contents of base address register 21 of the interruption table by a program other than the security-related program is prohibited as a part of the functions of CPU 1. Assuming that there are two stack pointers and one of the stack pointers is used solely by the security-related program, rewriting of the contents of the stack pointer by a program other than the security-related program may be prohibited. Further, rewriting of a register, which is used solely by the security-related program, by a program other than the security-related program may be prohibited.

As described above, the microcomputer in accordance with the present embodiment attains the same effect as in the first embodiment and, in addition, as the writing to base address register 21 is restricted, improper operation of security-related program or undermining of security can be prevented.

(Fifth Embodiment)

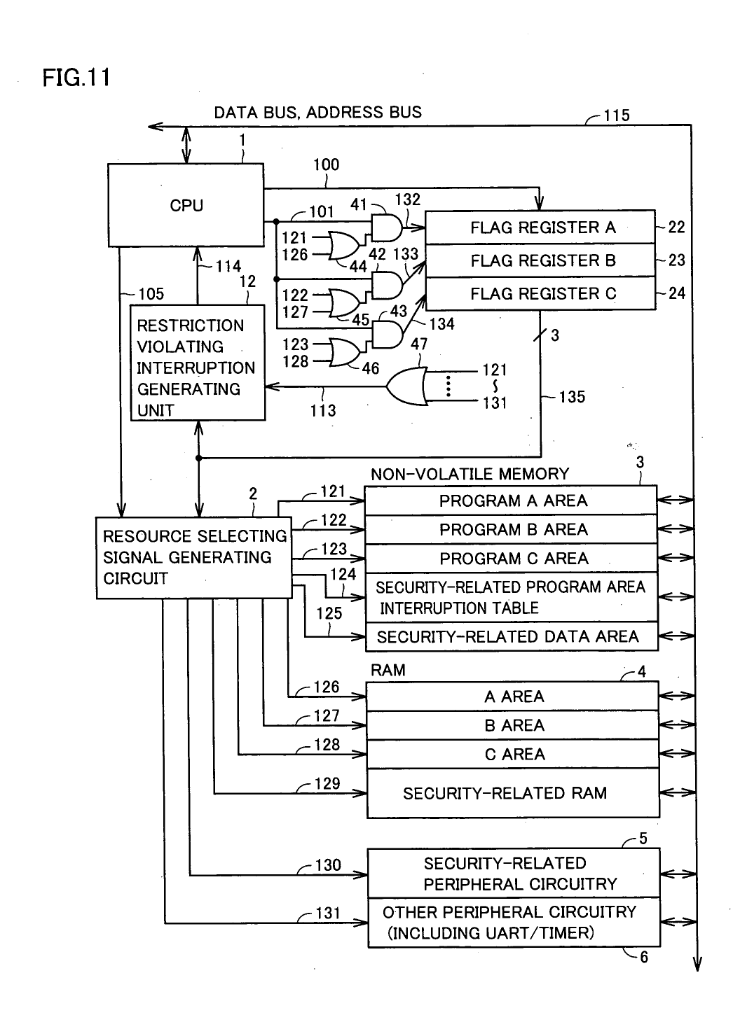

FIG. 11 is a block diagram schematically representing a configuration of a microcomputer in accordance with a fifth embodiment of the present invention. The microcomputer includes: a CPU 1, a resource selecting signal generating circuit 2 generating a signal for selecting a resource such as a memory or a peripheral circuit; a non-volatile memory 3; an RAM 4; security-related peripheral circuitry 5; security-unrelated peripheral circuitry 6; a restriction violating interruption generating circuit 12; flag registers A to C (22 to 24); AND circuits 41 to 43; and OR circuits 44 to 47.

Non-volatile memory 3 includes a program A area, a program B area, a program C area, a security-related program area, and a security-related data area. Further, RAM 4 includes A area, B area, C area and a security-related RAM area.

Resource selecting signal generating circuit 2 decodes an upper address on an address bus 105 output from CPU 1, and generates access signals 121 to 131. It is noted, however, that when flag A signal output from flag register A 22 is “0”, access signal 121 for accessing to program A area and access signal 126 for accessing to A area are masked, and when flag A signal is “1”, access signal 121 for accessing to program A area and access signal 126 for accessing to A area are output.

Further, resource selecting signal generating circuit 2 masks access signal 122 for accessing to program B area and access signal 127 for accessing to B area when flag B signal output from flag register B23 is “0” and outputs access signal 122 for accessing to program B area and access signal 127 for accessing to B area when flag B signal is “1”.

Further, resource selecting signal generating circuit 2 masks access signal 123 for accessing to program C area and access signal 128 for accessing to C area when flag C signal output from flag register C24 is “0” and outputs access signal 123 for accessing to program C area and access signal 128 for accessing to C area when flag C signal is “1”.

Further, resource selecting signal generating circuit 2 masks access signal 124 for accessing to a security-related program, an access signal 125 for accessing to a security-related data area, access signal 129 for accessing to a security-related RAM and access signal 130 for accessing to a security-related peripheral circuitry when any of flag A signal, flag B signal and flag C signal output from flag registers (22 to 24) is “1”, and outputs access signal 124 for accessing to a security-related program, an access signal 125 for accessing to a security-related data area, access signal 129 for accessing to a security-related RAM and access signal 130 for accessing to a security-related peripheral circuitry when flag A signal, flag B signal and flag C signal are all “0”.

It is noted that access signal 131 for accessing to other peripheral circuitry is not masked.

OR circuit 44 outputs “1” when access signal 121 for accessing to program A area or access signal 126 for accessing to A area is output, and otherwise outputs “0”. OR circuit 45 outputs “1” when access signal 122 for accessing to program B area or access signal 127 for accessing to B area is output, and otherwise outputs “0”. OR circuit 46 outputs “1” when access signal 123 for accessing to program C area or access signal 128 for accessing to C area is output, and otherwise outputs “0”.

OR circuit 47 outputs “1” when any of access signals 121 to 131 is output, and otherwise outputs “0”.

Flag registers A to C (22 to 24) attain to “0” when interruption execution notifying signal 100 output from CPU 1 is rendered active, and output “0” to flag A signal, flag B signal and flag C signal.

Flag register A22 attains to “1” when interruption return notifying signal 101 output from CPU 1 is active and access signal 121 for accessing to program A area or access signal 126 for accessing to A area is active, and outputs “1” to flag A signal.

Flag register B23 attains to “1” when interruption return notifying signal 101 output from CPU 1 is active and access signal 122 for accessing to program B area or access signal 127 for accessing to B area is active, and outputs “1” to flag B signal.

Flag register C24 attains to “1” when interruption return notifying signal 101 output from CPU 1 is active and access signal 123 for accessing to program C area or access signal 128 for accessing to C area is active, and outputs “1” to flag C signal.

Restriction violating interruption generating circuit 12 outputs a restriction violating interruption signal 114 to CPU 1 when flag A signal, flag B signal and flag C signal output from flag registers A to C (22 to 24) are all “0” and “0” is output form OR circuit 47. Specifically, restriction violating interruption generating circuit 12 outputs the restriction violating interruption signal to CPU 1, when access to the security-related information is prohibited and CPU 1 makes an access to the security-related information.

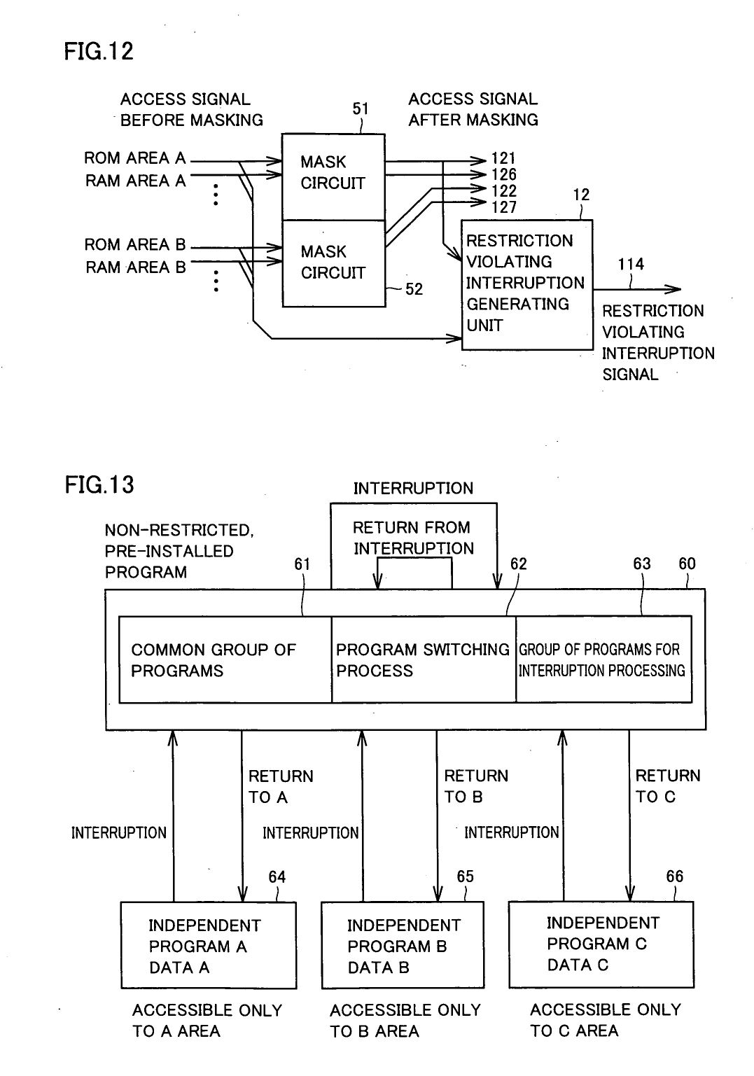

FIG. 12 shows an exemplary configuration of a resource selection signal generating circuit 2 in accordance with the fifth embodiment of the present invention. Resource selecting signal generating circuit 2 includes mask circuits 51 and 52. Though not shown, mask circuits and the like for program C area and C area are also implemented by similar configurations.

Mask circuit 51 masks an ROM area A signal and an RAM area A signal generated by decoding an upper address on address bus 105 output from CPU 1 when flag A signal is “0”, and outputs the same as access signal 121 for accessing to program A area and access signal 126 for accessing to A area. When flag A signal is “1”, ROM area A signal and RAM area A signal are directly output as access signal 121 for accessing to program A area and access signal 126 for accessing to A area.

Similarly, mask circuit 52 masks an ROM area B signal and an RAM area B signal generated by decoding an upper address on address bus 105 output from CPU 1 when flag B signal is “0”, and outputs the same as access signal 122 for accessing to program B area and access signal 127 for accessing to B area. When flag B signal is “1”, ROM area B signal and RAM area B signal are directly output as access signal 122 for accessing to program B area and access signal 127 for accessing to B area.

Restriction violating interruption generating circuit 12 compares ROM area A signal, RAM area A signal, ROM area B signal and RAM area B signal with access signal 121 for accessing to program A area, access signal 126 for accessing to A area, access signal 122 for accessing to program B area and access signal 127 for accessing to B area, and generates a restriction violating interruption signal 114. By way of example, when it is detected that ROM area A signal is masked by mask circuit 51 and access signal 121 for accessing to program A area is not output, restriction violating interruption signal 114 is output.

FIG. 13 is an illustration representing a software processing by the microcomputer in accordance with the fifth embodiment of the present invention. The software includes a non-restricted, pre-installed program 60, and independent programs A to C (64 to 66). Further, the non-restricted, pre-installed program 60 includes a common group 61 of programs (security-related programs), a program switching process 62, and a group 63 of programs for interruption processing.

When an interruption occurs while CPU 1 is executing independent program A64, flag registers A to C (22 to 24) are all cleared to “0”. When a process corresponding to the interruption such as a process by the common group 61 of programs ends and an interruption return instruction is executed, “1” is set in flag register A22, and the control returns to processing of independent program A64. In this state, flag registers B23 and C24 are “0”, and therefore, independent program B (data B) 65 and program C (data C) 66 cannot be accessed. Thus, programs A to C cannot access to the program (data) of each other.

The above-described non-restricted, pre-installed program 60 may include, in addition to the security-related program, a program for incorporating and deleting an independent program, a program for bug-fixing an independent program, a driver for peripheral circuitry and an OS.

As described above, in the microcomputer of the present embodiment, access to other program area is prohibited by flag registers A to C. Therefore, in addition to the effects described with reference to the first embodiment, it becomes possible to protect independent programs and to prevent interference among programs, and the amount of programs that are to be developed by the user can be reduced.

(Sixth Embodiment)

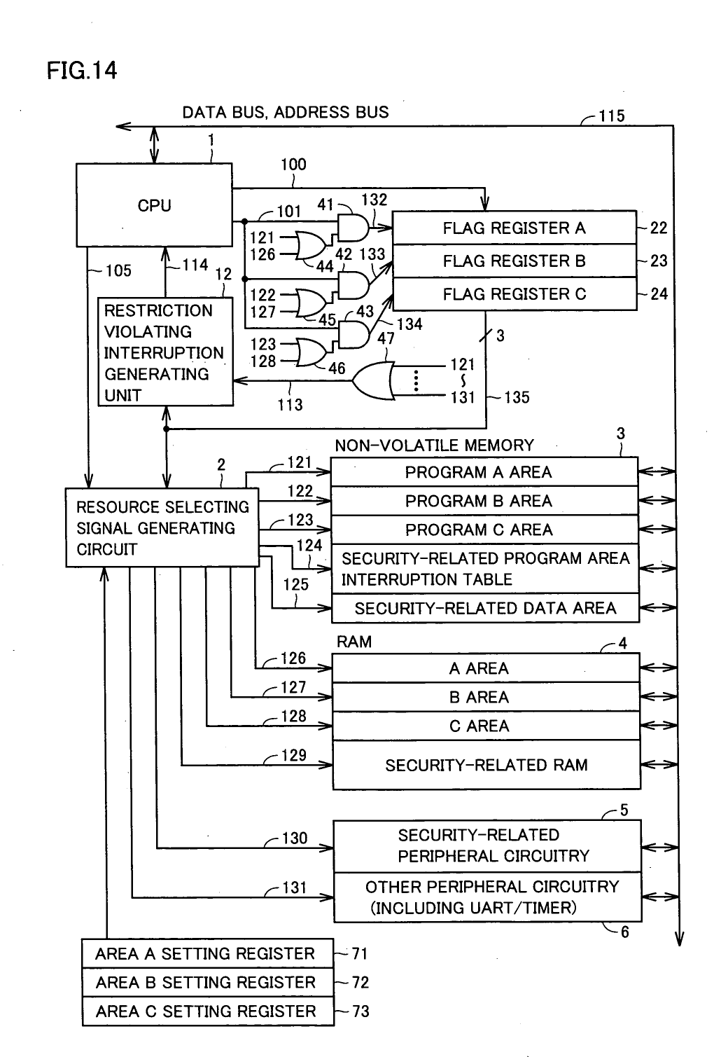

FIG. 14 a block diagram schematically representing a configuration of a microcomputer in accordance with a sixth embodiment of the present invention. As compared with the microcomputer in accordance with the fifth embodiment shown in FIG. 11, the present embodiment differs only in that an area A setting register 71, an area B setting register 72 and an area C setting register 73 are added, and that resource selecting signal generating circuit 2 has a different configuration. Therefore, detailed description of overlapping configurations and functions will not be repeated here.

In the fifth embodiment, area A (program A area, A area), area B (program B area, B area) and area C (program C area, C area) are fixed. In the present embodiment, these areas can be set by area A setting register 71, area B setting register 72 and area C setting register 73.

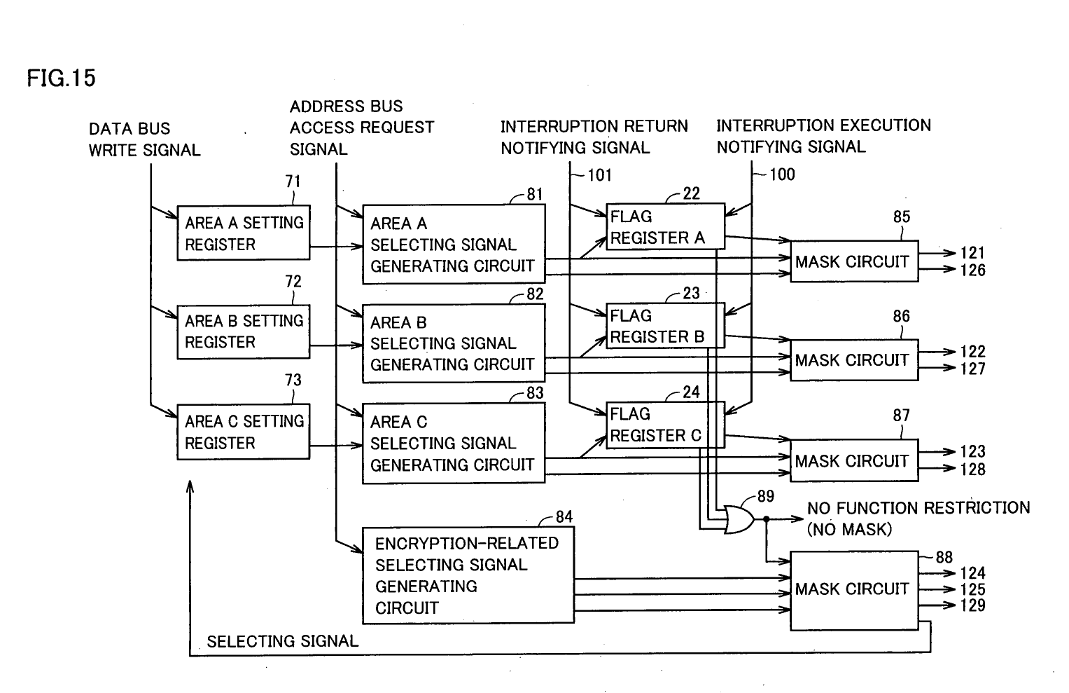

FIG. 15 shows an exemplary configuration of a resource selection signal generating circuit 2 in accordance with the sixth embodiment of the present invention. Resource selecting signal generating circuit 2 includes an area A selecting signal generating circuit 81, an area B selecting signal generating circuit 82, an area C selecting signal generating circuit 83, an encryption-related selecting signal generating circuit 84, mask circuits 85 to 88 and an OR circuit 89.

Area A selecting signal generating circuit 81 outputs an ROM area A signal or an RAM area A signal, when an address output to address bus 105 is within the area set by area A setting register 71 and an access request signal is active. Mask circuit 85 masks ROM area A signal and RAM area A signal output from area A selecting signal generating circuit 81, when flag A signal output from flag register A22 is “0”. When flag A signal is “1”, ROM area A signal and RAM area A signal are output directly as access signal 121 for accessing to program A area and access signal 126 for accessing to A area.

Area B selecting signal generating circuit-82 outputs an ROM area B signal or an RAM area B signal, when an address output to address bus 105 is within the area set by area B setting register 72 and an access request signal is active. Mask circuit 86 masks ROM area B signal and RAM area B signal output from area B selecting signal generating circuit 82, when flag B signal output from flag register B23 is “0”. When flag B signal is “1”, ROM area B signal and RAM area B signal are output directly as access signal 122 for accessing to program B area and access signal 127 for accessing to B area.

Area C selecting signal generating circuit 83 outputs an ROM area C signal or an RAM area C signal, when an address output to address bus 105 is within the area set by area C setting register 73 and an access request signal is active. Mask circuit 87 masks ROM area C signal and RAM area C signal output from area C selecting signal generating circuit 83, when flag C signal output from flag register C24 is “0”. When flag C signal is “1”, ROM area C signal and RAM area C signal are output directly as access signal 123 for accessing to program C area and access signal 128 for accessing to C area.

Encryption-related selecting signal generating circuit 84 decodes an address output to address bus 105, and generates an access signal to the security-related program area, security-related data area or to the security-related RAM area, when the access request is active. When an output of OR circuit 89 is “1”, that is, when any of the outputs from flag registers A to C (22 to 24) is “1”, mask circuit 88 masks an access signal from encryption-related selecting signal generating circuit 84. When the output of OR circuit 89 is “0”, that is, when the outputs from flag registers A to C (22 to 24) are all “0”, the access signal from encryption-related selecting signal generating circuit 84 is output as access signal 124 for accessing to security-related program area, access signal 125 for accessing to security-related data area or access signal 129 for accessing to security-related RAM area.

Mask circuit 88 masks selecting signals to area A setting register 71, area B setting register 72 and area C setting register 73, when the output of OR circuit 89 is “1”, that is, when any of the outputs from flag registers A to C (22 to 24) is “1”. This prevents any change to the contents of area A setting register 71, area B setting register 72 and area C setting register 73 by programs A to C.

As described above, in the microcomputer in accordance with the present embodiment, the program area and the data area can be set by area A setting register 71, area B setting register 72 and area C setting register 73. Therefore, in addition to the effects described with reference to the fifth embodiment, it becomes easier to change or add an independent program other than security-related ones, and hence, higher versatility can be attained.

Although the present invention has been described and illustrated in detail, it is clearly understood that the same is by way of illustration and example only and is not to be taken by way of limitation, the spirit and scope of the present invention being limited only by the terms of the appended claims.

1. A microcomputer executing a process while accessing to a specific area and a remaining non-specific area of a resource, comprising:
a processor;
a storing unit storing a flag limiting an access to said specific area;
a setting unit setting a value permitting an access to said specific area in said storing unit when said processor enters an interruption process, and setting a value prohibiting an access to said specific area in said storing unit when said processor returns from the interrupting process; and
a control unit controlling an access to said specific area and said non-specific area in accordance with a flag stored in said storing unit.

2. The microcomputer according to claim 1, wherein
said setting unit maintains a value permitting an access to said specific area stored in said storing unit when said processor returns from the interrupting process to a process of said specific area, and sets a value prohibiting an access to said specific area in said storing unit when said processor returns from the interrupting process to a process of said non-specific area.

3. The microcomputer according to claim 1, further comprising
a generating unit generating a restriction violating interruption to said processor, when said processor makes an access to said specific area while the value prohibiting an access to said specific area is stored in said storing unit.

4. The microcomputer according to claim 1, wherein
said processor restricts a part of functions of said processor, when the value prohibiting an access to said specific area is stored in said storing unit.

5. The microcomputer according to claim 4, wherein
said processor restricts writing to a base address register of an interruption table, when the value prohibiting an access to said specific area is stored in said storing unit.

6. The microcomputer according to claim 1, wherein
said non-specific area includes a plurality of areas;
said storing unit includes a plurality of flag registers corresponding to said plurality of areas;
said plurality of flag registers are all cleared when said processor enters an interrupting process, and when the processor returns from the interrupting process, a flag register corresponding to an area to be returned to is set; and
said control unit permits an access to said specific area when said plurality of flag registers are all cleared, and when any of said plurality of flag registers is set, permits an access to the area corresponding to the set flag register and prohibits an access to other areas.

7. The microcomputer according to claim 6, further comprising
a plurality of area setting units setting said plurality of areas; wherein
said control unit controls an access to said plurality of areas in accordance with the plurality of areas set by said plurality of setting units.

8. A microcomputer executing a process while accessing to a specific area and a remaining non-specific area of a resource, comprising:
a processor;
a counter incrementing a count value when said processor enters an interruption process and decrementing the count value when said processor returns from the interrupting process; and
a control unit controlling an access to said specific area and said non-specific area in accordance with the count value of said counter.

9. The microcomputer according to claim 8, wherein
in said counter, “0” is set at initialization; and
said control unit prohibits an access to said specific area when the count value of said counter is “0” and permits an access to said specific area when the count value of said counter is not smaller than “1”.

10. The microcomputer according to claim 8, further comprising
a storing unit storing a flag limiting an access to said specific area; wherein
said processor clears a flag in said storing unit when a process proceeds from said non-specific area to said specific area, and sets the flag in said storing unit when the process proceeds from said specific area to said non-specific area; and
said control unit prohibits an access to said specific area when the count value of said counter is “0” and said flag is set in said storing unit, and otherwise permits an access to said specific area.

11. The microcomputer according to claim 10, further comprising
a generating unit generating a restriction violating interruption to said processor, when the count value of said counter is “0”, said flag in said storing unit is set and said processor makes an access to said specific area.

12. The microcomputer according to claim 10, wherein
said processor restricts a part of functions of said processor, when the value prohibiting an access to said specific area is stored in said storing unit.

13. The microcomputer according to claim 12, wherein
said processor prohibits writing to a base address register of an interruption table, when the value prohibiting an access to said specific area is stored in said storing unit.
